(19) United States
(12) Patent Application Publication
(10) Pub. No.: US 2021/0332519 A1
(43) Pub. Date: Oct. 28, 2021

(54) INTELLIGENT WASHING MACHINE AND CONTROL METHOD THEREOF

(71) Applicant: LG ELECTRONICS INC., Seoul (KR)

(72) Inventor: Yunsik PARK, Seoul (KR)

(73) Assignee: LG ELECTRONICS INC., Seoul (KR)

(21) Appl. No.: 16/490,052

(22) PCT Filed: Jul. 12, 2019
(86) PCT No.: PCT/KR2019/008678

§ 371 Date: Aug. 29, 2019

(51) Int. Cl. D06F 33/34; D06F 34/18; D06F 33/36; D06F 39/08

(52) U.S. Cl. CPC D06F 33/34; D06F 34/18; D06F 2103/06; D06F 39/088; D06F 33/36

(57) ABSTRACT

Disclosed herein is a method of controlling an intelligent washing machine includes: obtaining a laundry image of laundry placed in a washing tub; extracting laundry classification information from the laundry image; calculating an estimated water supply time on the basis of the laundry classification information; and extending the reference water supply time if the estimated water supply time exceeds a predetermined reference water supply time, and supplying water to the washing tub for the extended reference water supply time. The washing machine may be associated with an artificial intelligence (AI) module, an unmanned aerial vehicle (UAV) (or drone), a robot, an augmented reality (AR) device, a virtual reality (VR) device, and a device related to a 5G service.

### TECHNICAL FIELD

The present invention relates an intelligent washing machine and a control method thereof, and more particularly, to an intelligent washing machine and a control method thereof which may improve a phenomenon in which a water supply error occurs.

### BACKGROUND ART

In general, a washing machine refers to various apparatuses for treating laundry by applying a physical and/or chemical action to the laundry such as clothes, bedding, and the like. The washing machine includes an outer tub that holds wash water and an inner that holds laundry and is rotatably installed in the outer tub. A washing method of a general washing machine includes a washing process of washing the laundry by rotating the inner tub and a spin-drying process of dewatering the laundry using a centrifugal force of the inner tub.

A washing process of washing laundry includes a process of supplying wash water so that the laundry is soaked. The water supply process of supplying wash water is performed for a predetermined reference water supply time. Since the amount of supplied water in units of time varies depending on an environment in which the washing machine is installed, the reference water supply time should be secured for a sufficiently long time. However, the reference water supply time must be set to be sufficiently long in order to supply sufficient wash water. Here, if the reference water supply time is set to be too long, there may be a disadvantage in that a washing process must be prepared with power of the washing machine turned on even in a state where it is impossible to supply water supply due to a problem of the water supply process.

Meanwhile, if the reference water supply time is set to be too short, a situation where a large amount of water is required depending on laundry may not be handled and a water supply error may occur, even though there is no problem in the water supply process.

### DISCLOSURE

### Technical Problem

An embodiment of the present invention aims to solve the above-mentioned problem.

Furthermore, an embodiment of the present invention provides an intelligent washing machine and a control method thereof capable of efficiently adjusting a water supply time.

Furthermore, an embodiment of the present invention provides an intelligent washing machine and a control method thereof capable of reducing a water supply error phenomenon by adjusting a water supply time according to laundry.

### Technical Solution

Furthermore, in this specification, a method of controlling an intelligent washing machine includes: obtaining a laundry image of laundry placed in a washing tub; extracting laundry classification information from the laundry image; calculating an estimated water supply time on the basis of the laundry classification information; and extending the reference water supply time if the estimated water supply time exceeds a predetermined reference water supply time, and supplying water to the washing tub for the extended reference water supply time.

The calculating of the estimated water supply time may include calculating the estimated water supply time to be equal to or greater than the reference water supply time if the laundry classification information includes error information indicating a water supply error history.

The extracting of the laundry classification information may include: extracting a laundry object from the laundry image; and searching a water content percentage weight for the laundry object from a look-up table storing the water content percentage weight for the laundry object.

The calculating of the estimated water supply time may include calculating the estimated water supply time to be equal to or greater than the reference water supply time if the sum of the water content percentage weights of laundry items belonging to the laundry image is greater than or equal to a predetermined threshold.

The method may further include: preparing the look-up table storing the water content percentage weight for the laundry object, wherein the water content percentage weight for the laundry object may be set to be proportional to a degree to which the laundry object belongs to the laundry image causing a water supply error.

The setting of the water content percentage weight for the laundry object may include: obtaining a first laundry image in a first washing process; assigning error information to the first laundry image if a water supply error occurs in the first washing process; obtaining an nth laundry image in an nth washing process; assigning error information to the nth laundry image if a water supply error occurs in the nth washing process; and setting a water content percentage weight to be proportional to a degree to which each laundry object belongs to the laundry image assigned the error information.

The setting of the water content percentage weight may include extracting overlapping laundry objects overlapping each other, and non-overlapping laundry objects not overlapping each other, among laundry objects belonging to the first to nth laundry images; and assigning the water content percentage weight such that the overlapping laundry objects have a water content percentage weight higher than the non-overlapping laundry objects.

The first laundry image to the nth laundry image may be obtained from an image of the laundry placed in the washing tub.

Each step of obtaining the first laundry image to the nth laundry image may include obtaining a plurality of images, while tumbling the washing tub.

Each step of the first laundry image to the nth laundry image may be obtained by monitoring a clothing box disposed outside the washing tub.

The method may further include: receiving, from a network, downlink control information (DCI) used for scheduling transmission of the laundry image or the laundry classification information, wherein the laundry image of the laundry or the laundry classification information may be transmitted to the network on the basis of the DCI.

The method may further include: performing an initial access procedure with the network on the basis of a synchronization signal block (SSB), wherein the laundry image of the laundry or the laundry classification information is transmitted to the network through a physical uplink shared channel (PUSCH) and the SSB and a demodulation reference signal (DM-RS) of the PUSCH may be quasi-co-located, QCL, for a QCL type D.

Furthermore, in this specification, an intelligent washing machine includes: a washing tub in which laundry is placed; an image obtaining unit obtaining a laundry image of the laundry placed in the washing tub; a water supply valve controlled to supply water to the washing tub for a reference water supply time in response to a washing command; and a controller obtaining laundry classification information from the laundry image, calculating an estimated water supply time on the basis of the laundry classification information, and controlling the water supply valve to supply water for a period equal to or greater than the reference water supply time if the estimated water supply time is equal to or greater than the reference water supply time.

The controller may calculate the estimated water supply time to be equal to or greater than the reference water supply time if the laundry classification information includes error information indicating a water supply error history.

The controller may extract a laundry object from the laundry image and search a water content percentage weight of the laundry object from a look-up table storing the water content percentage weight of the laundry object.

The controller may calculate the estimated water supply time to be equal to or greater than the reference water supply time if the sum of the water content percentage weights of the laundry items included in the laundry image is equal to or greater than a predetermined threshold.

### Advantageous Effects

According to the present invention, it is possible to reduce a water supply error phenomenon by adjusting a water supply time according to laundry.

Further, according to the present invention, since the water supply time may be extended depending on laundry, it is not necessary to set the reference water supply time to be too long in advance, and thus, it is not necessary for the washing machine to check a water supply situation for a long time in a situation where a water supply problem occurs.

### DESCRIPTION OF DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIGS. 4 and 5 are views illustrating an intelligent washing machine according to an embodiment of the present invention.

FIG. 6 is a block diagram illustrating a configuration of an intelligent washing machine according to an embodiment of the present invention.

FIG. 7 is a block diagram of an AI device according to an embodiment of the present invention.

FIG. 8 is a flowchart illustrating a method of controlling an intelligent washing machine according to an embodiment of the present invention.

FIG. 9 is a flowchart illustrating a method of assigning error information according to an embodiment of the present invention.

FIG. 10 is a flowchart illustrating a method of controlling a washing machine according to another embodiment of the present invention.

FIG. 11 is a flowchart illustrating a method of assigning a water content percentage weight according to an embodiment of the present invention.

FIG. 12 is a flowchart illustrating a method of controlling a washing machine according to another embodiment of the present invention.

FIG. 13 is a view illustrating an example of assigning a water content percentage weight according to an embodiment of the present invention.

FIG. 14 is a view illustrating a method of obtaining a laundry image according to an embodiment of the present invention.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

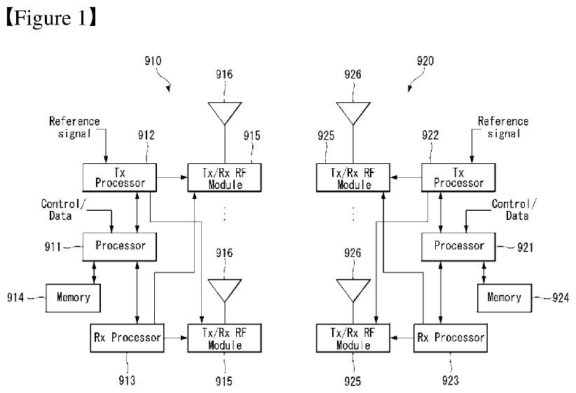

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

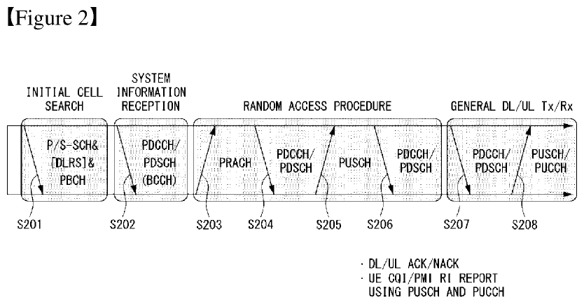

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionlnDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

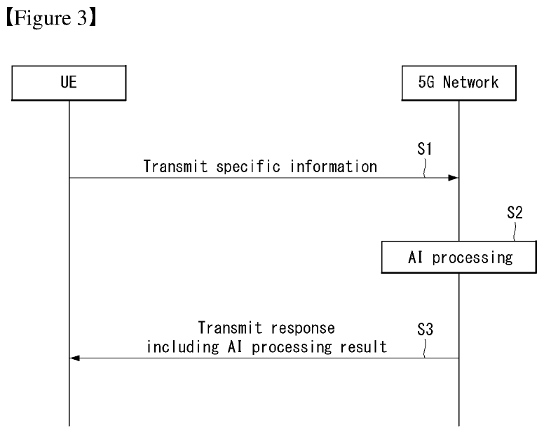

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology may be applied in combination with the methods proposed in the present invention to be described later or may be supplemented to specify or clarify technical features of the methods proposed in the present invention.

Intelligent Washing Machine

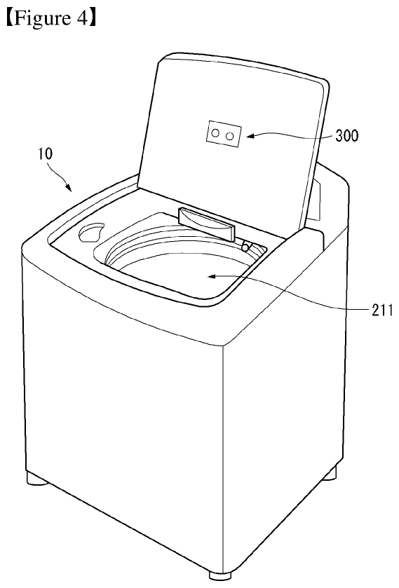

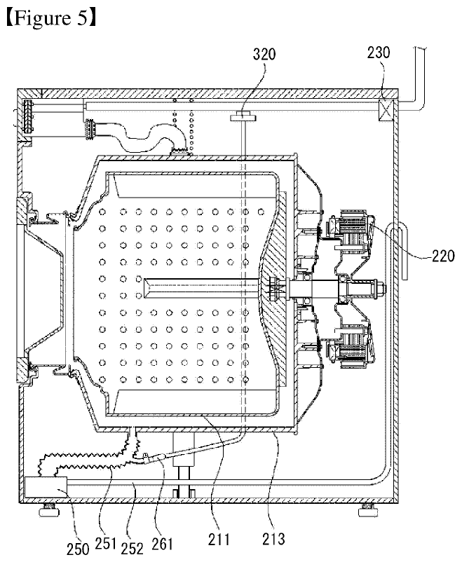

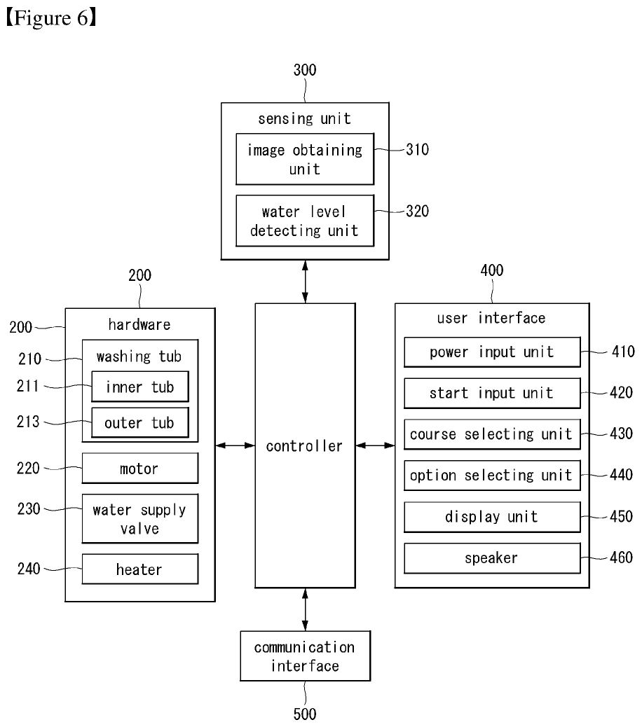

FIG. 4 is an external perspective view of an intelligent washing machine according to an embodiment of the present invention, and FIG. 5 is a cross-sectional view of an intelligent washing machine according to an embodiment of the present invention. FIG. 6 is a block diagram illustrating main components of the washing machine shown in FIGS. 4 and 5.

Referring to FIGS. 4 through 6, a washing machine 10 according to an embodiment of the present invention includes a controller 100, a hardware unit 200, a sensing unit 300, a user interface 400, and a communication interface 500.

The controller 100 controls driving of the washing machine 10 by controlling the hardware 200 according to information input through the user interface 400.

In particular, the controller 100 may adjust a water supply time for supplying wash water on the basis of a laundry image of laundry obtained through the image obtaining unit 310.

An operation of the hardware 200 is controlled. More specifically, the controller 100 may obtain laundry classification information from the laundry image and calculate an estimated water supply time on the basis of the classification information. If the estimated water supply time is equal to or greater than a reference water supply time, the controller 100 may control a water supply valve to supply water for a period equal to or greater than the reference water supply time. The reference water supply time corresponds to a time for supplying water so that washing may be smoothly performed at a limit value of washing capacity, and may be set in advance in consideration of capacity of a washing tub 210 and general pipe capacity for supplying water.

The hardware 200 may include the washing tub 210, a motor 220, a water supply valve 230, a heater 240, and the like.

The washing tub 210 includes an outer tub 213 accommodating wash water and an inner tub 211 disposed on an inner side of the outer tub 213, allowing laundry to be placed therein, and rotating using a rotational force provided from the motor 220. The water supply valve 230 controls supply of wash water. The heater 240 heats the water supplied in the washing tub.

Further, the hardware 200 includes a drain pump 250, a bellows 251, a drain hose 252, and an air chamber 261 as shown in FIG. 5. The drain pump 250 drains wash water in the washing tub 210. The drain pump 250 is provided at lower ends of the inner tub 211 and the outer tub 213 and is connected to the outer tub 213 through the bellows 251 to allow wash water of the inner tub 211 and the outer tub 213 to be drained to the outside through the drain hose 252.

The sensing unit 300 includes an image obtaining unit 310 and a water level detecting unit 320.

The image obtaining unit 310 obtains an image of the laundry placed in the inner tub 211. The image obtaining unit 310 may use at least one of a 2D or 3D camera and may be disposed on a cover of the washing machine 10. The water level detecting unit 320 detects the wash water supplied in the washing tub 210. In particular, the water level detecting unit 320 detects whether the wash water reaches a reference water level. The reference water level may be set to a water supply amount in advance at which washing is performed smoothly.

The user interface 400 may include a power input unit 410, a start input unit 420, a course selecting unit 430, an option selecting unit 440, a display unit 450, and a speaker 460.

The power input unit 410 provides a means for controlling ON/OFF of a main power source of the washing machine. The start input unit 420 provides a means for controlling start of a washing process, a rinsing process, or a spin-drying process. The course selecting unit 430 provides a means for selecting a kind of the washing process, rinsing process or spin-drying process. The option selecting unit 440 provides a means for selecting detailed options for performing the washing process, the rinsing process, or the spin-drying process. For example, the option selecting unit 440 may be a means for selecting options such as a temperature of water, time, and reservation. The display unit 450 may display an operational state of the washing machine 10 or display course information selected by the user through the course selecting unit 430 or option information selected through the option selecting unit 440. The speaker 460 outputs an operational state of the washing machine 10 or a situation regarding a specific event by a voice signal. The specific event may be a situation such as laundry dispersion control or RPM control on the basis of the laundry image.

A communication interface 500 may further include various additional components such as a wireless communication module (not shown) for wireless communication or a tuner (not shown) for tuning a broadcast signal. In addition to receiving signals from an external device, the communication interface 500 may also transmit information/data/signals of an air-cleaner to the external device. That is, the communication interface 500 may not be limited to the component for receiving a signal of an external device and may be implemented as an interface available for bidirectional communication. The communication interface 500 may receive a control signal for selecting a UI from the plurality of control devices. The communication interface 500 may be configured as a known communication module for short-range wireless communication such as wireless LAN (Wi-Fi), Bluetooth, infrared (IR), ultra wideband (UWB), Zigbee, configured as a mobile communication module such as 3G, 4G, LTE, or 5G, or may be configured as a known communication port for wired communication. The communication interface 500 may be used for various purposes, such as a command for operating a display, transmitting and receiving data, and the like, in addition to a control signal for selecting a UI.

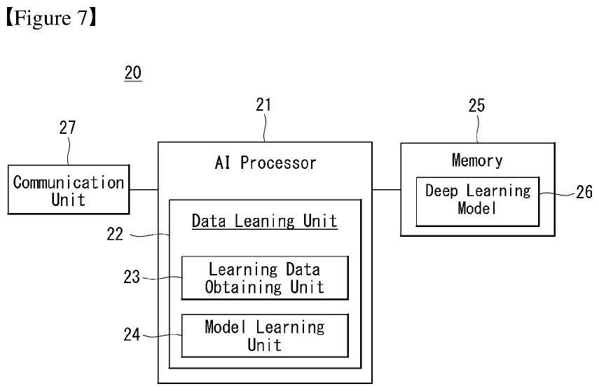

FIG. 7 is a block diagram of an AI device according to an embodiment of the present invention.

Referring to FIG. 7, an AI device 20 may include an electronic device including an AI module capable of performing AI processing or a server including an AI module. In addition, the AI device 20 may be included as a component of at least a portion of the washing machine 10 shown in FIGS. 4 and 5 and provided to perform at least portion of the AI processing together.

AI processing may include all operations related to the controller 100 of the washing machine 10 shown in FIG. 4. For example, the washing machine 10 may AI-process the laundry image or laundry classification information or laundry dispersion information to perform processing/determination and control signal generating operation.

The AI device 20 may be a client device that directly uses the AI processing result or may be a device in a cloud environment that provides the AI processing result to another device. The AI device 20, which is a computing device that can learn a neural network, may be implemented as various electronic devices such as a server, a desktop PC, a notebook PC, and a tablet PC.

The AI device 20 may include an AI processor 21, a memory 25, and/or a communication unit 27.

The AI processor 21 may learn a neural network using a program stored in the memory 25. In particular, the AI processor 21 may learn a neural network for recognizing related data of the washing machine 10. Here, the neural network for recognizing the related data of the washing machine 10 may be designed to simulate a human brain structure in a computer and include a plurality of network nodes having weights that simulate the neurons of the human neural network. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural network model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

In addition, the learning data selecting unit may select data necessary for learning from among the learning data obtained by the learning data obtaining unit 23 or the learning data preprocessed by the preprocessing unit. The selected training data may be provided to the model learning unit 24. For example, the learning data selecting unit may detect a specific area of an image obtained through an image capturing unit of the washing machine 10, thereby selecting only data regarding an object included in the specific area as learning data.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. For example, the external electronic device may include a Bluetooth device, an autonomous vehicle, a robot, a drone, an AR device, a mobile device, a home appliance, and the like.

Meanwhile, the AI device 20 shown in FIG. 7 was functionally separately described into the AI processor 21, the memory 25, the communication unit 27, etc., but it should be noted that the aforementioned components may be integrated in one module and referred to as an AI module.

Method of Controlling Intelligent Washing Machine

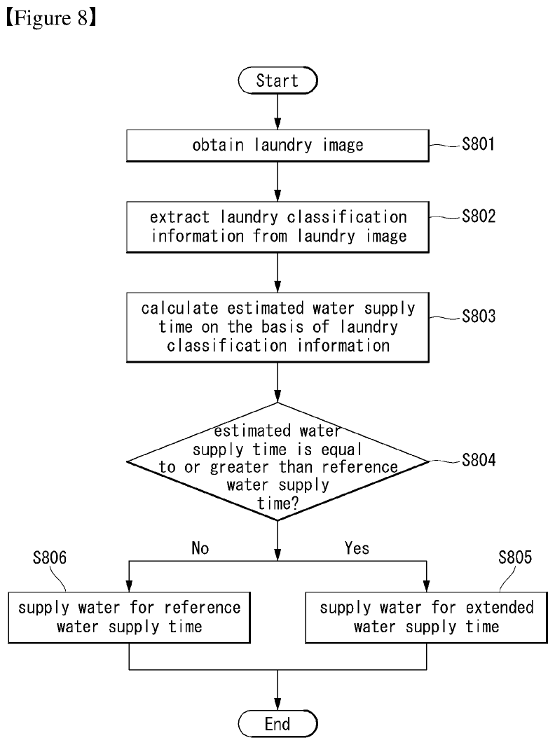

FIG. 8 is a flowchart illustrating a method of controlling a washing machine according to the present invention.

Referring to FIG. 8, in the method of controlling a washing machine according to the present invention, in a first step S801, a laundry image is obtained. The image obtaining unit 310 may obtain an image of laundry placed in the inner tub 211 according to a washing start command.

In a second step S802, laundry classification information is extracted from the laundry image.

The controller 100 may extract laundry classification information from the laundry image. The laundry classification information includes error information or water content percentage information for each laundry item. The controller 100 may obtain a kind, material, or water content percentage information of each laundry item by comparing the image of the laundry or feature points of the image with a predetermined image or feature points. As will be described later, the laundry classification information may be updated by learning the laundry image and whether a water supply error occurs.

In a third step S803 and a fourth step S804, an estimated water supply time is calculated on the basis of the laundry classification information. Further, it is determined whether the estimated water supply time is equal to or greater than a reference water supply time. The estimated water supply time does not have to be a physical time unit. The controller 100 may determine only whether the estimated water supply time calculated on the basis of the laundry classification information is equal to or greater than the reference water supply time.

The controller 100 may search for error information or a water content percentage weight from the laundry classification information to calculate the estimated water supply time.

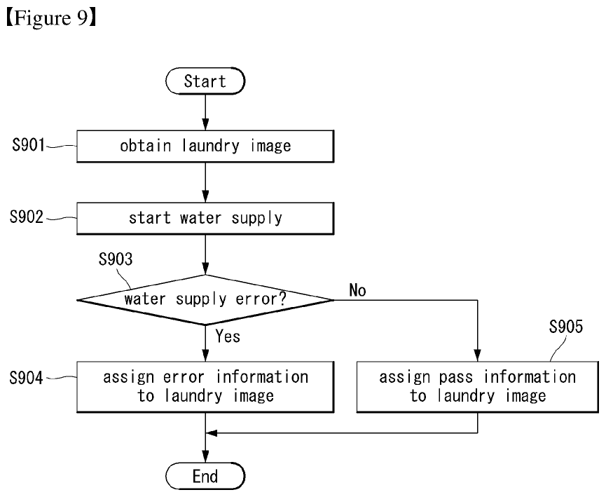

If the laundry classification information includes error information, the controller 100 may determine that the estimated water supply time of a corresponding laundry image is equal to or greater than the reference water supply time. The error information indicates a water supply error history and indicates that an error has occurred when water was supplied in a state where the laundry corresponding to the laundry image is placed in the inner tub 211. A method of assigning error occurrence information will be described later with reference to FIG. 9.

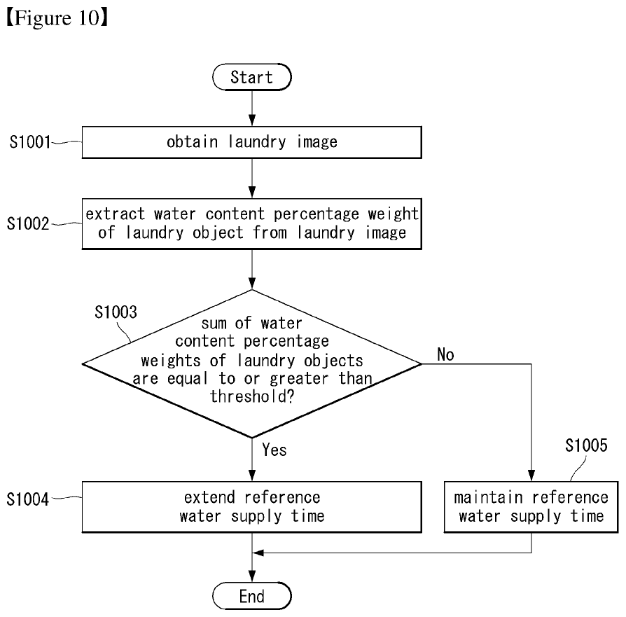

The controller 100 may add water content percentages of the laundry objects belonging to the laundry classification information, and determine that the estimated water supply time is equal to or greater than the reference water supply time if the sum of the water content percentages is equal to or greater than a predetermined threshold. A specific embodiment of controlling a reference water supply time on the basis of a water content percentage weight will be described later with reference to FIG. 10.

In a fifth step S805, if the estimated water supply time is equal to or greater than the reference water supply time, the controller 100 extends the reference water supply time and supplies water for the extended water supply time. That is, the controller 100 allows the water to be supplied to the washing tub 210 for a longer time.

In a sixth step S806, if the estimated water supply time is equal to or greater than the reference water supply time, the controller 100 performs water supply on the basis of the predetermined reference water supply time.

FIG. 9 is a flowchart illustrating a method of assigning error information according to an embodiment of the present invention.

Referring to FIG. 9, in a first step S901, the image obtaining unit 310 obtains a laundry image. In order to obtain the laundry image, the same method as the first step S801 illustrated in FIG. 8 may be used.

In a second step S902, the controller 100 performs a water supply operation in response to a washing start command.

In a third step S903, the controller 100 determines whether a water supply error occurs. The water supply error refers to a situation in which water is not supplied to the washing tub 210 at a predetermined level during the reference time.

In a fourth step (S904), when a water supply error occurs, the controller 100 assigns error information to the laundry image obtained in the first step S901, matches the laundry image and the error information, and stores the same in a database.

In the fifth step (S905), if no water supply error occurs, the controller 100 assigns pass information to the laundry image obtained in the first step S901, matches the laundry image and the pass information, and stores the same in the database.

FIG. 10 is a flowchart illustrating a method of controlling a washing machine according to another embodiment of the present invention. FIG. 10 relates to a method of calculating an estimated water supply time on the basis of a water content percentage weight.

Referring to FIG. 10, in a first step S1001, the image obtaining unit 310 obtains a laundry image. In order to obtain the laundry image, the same method as in first step S801 illustrated in FIG. 8 may be used.

Alternatively, in order to separate the laundry objects from the laundry image, the image obtaining unit 310 may obtain a plurality of laundry images. For example, the laundry items placed on a bottom surface of the inner tub 211 may not be checked by single image capturing. To this end, the controller 100 may tumble the washing tub 210 to move the positions of the laundry items disposed in the inner tub 211. That is, the controller 100 may obtain a plurality of laundry images by using the image obtaining unit 310, while tumbling the washing tub 210.

In a second step S1002, the water content percentage weight of the laundry object is extracted from the laundry image. To this end, the controller 100 may extract the laundry objects from the laundry image. The laundry object refers to individual laundry and may be sole clothes. Alternatively, a pair of clothes such as socks may be classified as one laundry object. The controller 100 may extract an object that may be separated from the 2D or 3D image by using an object extraction method of a known technique and may identify each object as a laundry object.

The controller 100 may search for a look-up table in which the water content percentage weights for the laundry objects are stored, and extract the water content percentage weights for the laundry objects. The water content percentage weight is set to be proportional to a degree to which each laundry object belongs to the laundry image that causes a water supply error.

In a third step S1003, the controller 100 compares the sum of the water content percentage weights of the laundry objects with a predetermined threshold. Table 1 below shows an example of a look-up table in which laundry objects and water content percentage weights are matched.

TABLE 1

| Laundry object | Water content percentage weight |
|---|---|
| a | Wa |
| b | Wb |
| c | Wc |

If the laundry objects extracted from the laundry image correspond to “a”, “b”, and “c”, the controller 100 searches the look-up table and calculates the sum of the water content percentage weights to “Wa+Wb+Wc”. If the predetermined threshold weight is “Wref”, the controller 100 determines whether “Wa+Wb+Wc” corresponding to the sum of the water content percentage weights is greater than or equal to “Wref”.

In a fourth step S1004, if the sum of the water content percentage weights is equal to or greater than the threshold weight, the controller 100 extends the reference water supply time. That is, the controller 100 supplies water for a time longer than the reference water supply time.

In a fifth step S1005, if the sum of the water content percentage weights is less than the threshold weight, the controller 100 provides water supply for the predetermined reference water supply time.

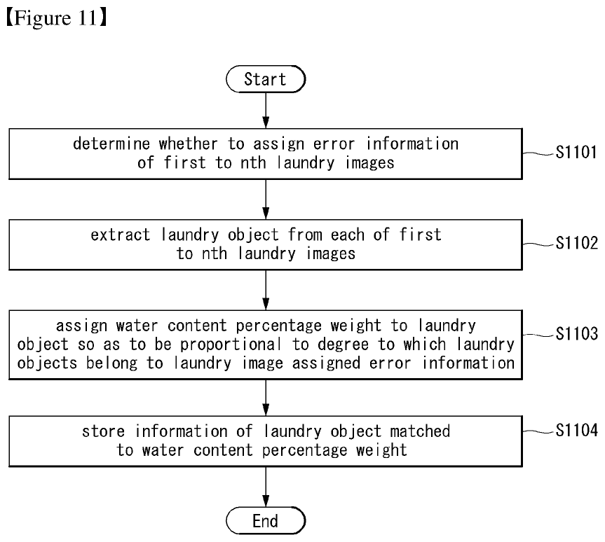

FIG. 11 is a flowchart illustrating a method of setting a look-up table in which laundry objects and Water content percentage weights are matched.

A method of setting a look-up table will be described with reference to FIG. 11.

In a first step S1101, a determination is performed to assign error information of first to nth laundry images. The first laundry image refers to a laundry image obtained in a first washing process, and the nth laundry image refers to a laundry image obtained in an nth washing process. That is, each of the first to nth laundry images may be obtained through the same method as in the above embodiments.

In a second step S1102, a laundry object is extracted from each of the first to nth laundry images. The controller 100 extracts laundry objects belonging to the first laundry image. The controller 100 extracts laundry objects belonging to the second laundry image. Similarly, the controller 100 extracts laundry objects belonging to the nth laundry image.

In a third step (S1103), the controller 100 assigns a water content percentage weight to the respective laundry objects extracted from the laundry images. The controller 100 may assign a water content percentage weight to each laundry object in proportion to a degree to which each laundry object belongs to the laundry image assigned the error information.

In a fourth step S1104, the controller 100 stores information of the laundry objects matched to the water content percentage weights in a database.

As described above, the flowchart shown in FIG. 11 is not limited to order of time. For example, the first step S1101 and the second step S1102 may be performed in parallel at the same time. Therefore, a first laundry image may be obtained and a laundry object may be extracted from the first laundry images. Subsequently, a second laundry image may be obtained and a laundry object may be extracted from the second laundry images.

Similarly, the third step S1103 does not need to be limited in time order.

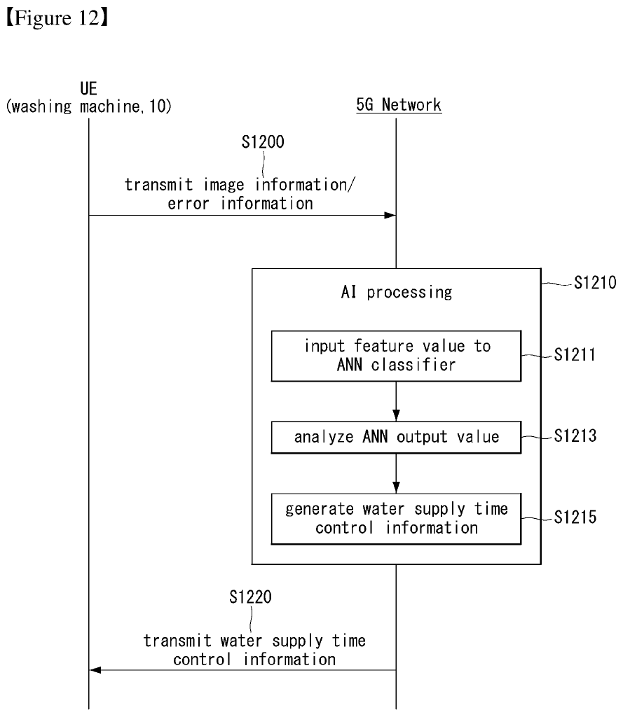

FIG. 12 is a flowchart illustrating a method of controlling a washing machine according to another embodiment of the present invention.

Referring to FIG. 12, the controller 100 may control the communication unit to transmit state information of the washing machine 10 to an AI processor included in the 5G network. Further, the controller 100 may control the communication unit to receive AI-processed information from the AI processor. The AI-processed information may include laundry image information, error information, and the like.

The controller 100 may transmit laundry image information and error information from the washing machine 10 to the network on the basis of the DCI. The laundry image information and error information may be transmitted to the network via a physical uplink shared channel (PUSCH) and a synchronization signal block (SSB) and a demodulation reference signal (DM-RS) of the PUSCH may be quasi-co-located, QCL, for a QCL type D.

In detail, the washing machine 10 may transmit short-circuit information along with the image information or feature values to the 5G network (S1200).

Here, the 5G network may include an AI processor or an AI system, and the AI system of the 5G network may perform AI processing on the basis of the received image information.

The controller 100 generates short-circuit information if a short-circuit occurs in the washing process or the spin-drying process of the washing machine 10, and transmits the short-circuit information to the 5G network.

The AI system may input the laundry image information or error information received from the washing machine 10 to the ANN classifier (S1211). The AI system may analyze an ANN output value (S1213) and calculate a water content percentage weight for the laundry object from the ANN output value. Also, the AI system generates water supply time control information (S1215).

The 5G network may transmit the water supply time control information determined by the AI system to the washing machine 10 through the wireless communication unit (S1220). The water supply time control information may be information regarding whether to maintain the reference water supply time or extend the reference water supply time according to water content percentage weights.

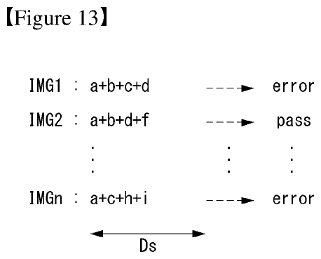

FIG. 13 is a view illustrating an embodiment in which a water content percentage weight is assigned.

The method of assigning the water content percentage weight shown in FIG. 13 may also be applied to the embodiment shown in FIGS. 11 and 12.

Referring to FIG. 13, each of the first laundry images IMG1 to nth laundry images IMGn includes laundry object information Ds and presence or absence of error information.

The first laundry image IMG1 includes laundry objects of “a”, “b”, “c”, and “d” and has error information. The second laundry image IMG2 includes laundry objects of “a”, “b”, “d”, and “f” and does not have error information. The nth laundry image IMGn includes laundry objects of “b”, “c”, “f”, and “i” and has error information.

The controller 100 extracts overlapping laundry objects and non-overlapping laundry objects from among the laundry objects belonging to the first laundry image IMG1 to nth laundry images IMGn. The controller 100 may set the overlapping laundry objects to have a water content percentage weight higher than that of the non-overlapping laundry objects.

For example, when comparing the first laundry image IMG1 and the second laundry image IMG2, the overlapping laundry objects are “a”, “b”, and “d”. Non-overlapping laundry objects that do not overlap each other are “c” and “f”. The controller 100 may assign a water content percentage weight higher than that of “f” to “c” included in the error information in the process of assigning the water content percentage weights of the laundry objects.

In this manner, by calculating relative water content percentage weights between the laundry objects in the plurality of laundry images, the water content percentage weights of all the laundry objects may be assigned.

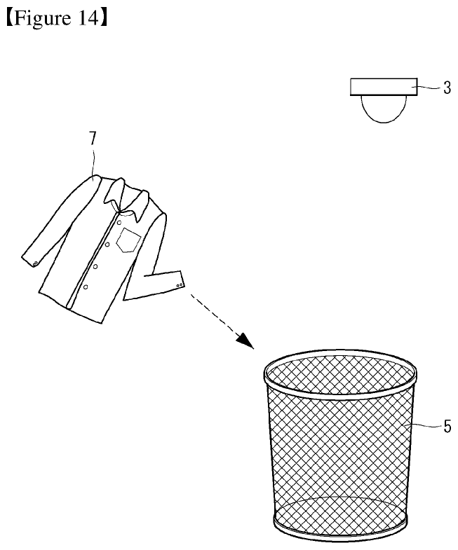

FIG. 14 is a view illustrating a method of obtaining a laundry image according to another embodiment of the present invention.

Referring to FIG. 14, the laundry image in another embodiment of the present invention may be obtained by monitoring a clothing box disposed outside the washing machine.

For example, an image capturing device 3 monitors a clothing box 5 or the like to obtain a laundry image. The image capturing device 3 may transmit the laundry image to the washing machine 10 through a communication unit (not shown) or transmit the laundry image to a 5G network.

The controller 100 of the washing machine or a processor of the 5G network may assign water supply error information or a water content percentage weight to the corresponding laundry image on the basis of the embodiments described above if laundry items corresponding to the laundry image provided from the image capturing device 3 cause a water supply error.

Event Notification

In an embodiment of the present disclosure, the controller 100 may transmit a voice signal through a speaker 460 if a specific event occurs or in order to indicate an overall operational state of the washing machine 10. For example, the controller 100 may transmit a watery supply error event corresponding to the third step S903 illustrated in FIG. 9 by a voice signal, thereby requesting the user to take additional measures.

The components described herein are to be considered as illustrative and not restrictive in all aspects. The scope of the present invention should be determined by reasonable interpretation of the appended claims, and all changes within the equivalent range of the present invention are included in the scope of the present invention.

1. A method of controlling an intelligent washing machine, the method comprising:
obtaining a laundry image of laundry placed in a washing tub; extracting laundry classification information from the laundry image;
calculating an estimated water supply time on the basis of the laundry classification information; and
extending the reference water supply time if the estimated water supply time exceeds a predetermined reference water supply time, and supplying water to the washing tub for the extended reference water supply time.

2. The method of claim 1, wherein
the calculating of the estimated water supply time comprises:
calculating the estimated water supply time to be equal to or greater than the reference water supply time if the laundry classification information includes error information indicating a water supply error history.

3. The method of claim 1, wherein
the extracting of the laundry classification information comprises:
extracting a laundry object from the laundry image; and
searching a water content percentage weight for the laundry object from a look-up table storing the water content percentage weight for the laundry object.

4. The method of claim 3, wherein
the calculating of the estimated water supply time comprises:
calculating the estimated water supply time to be equal to or greater than the reference water supply time if the sum of the water content percentage weights of laundry items belonging to the laundry image is greater than or equal to a predetermined threshold.

5. The method of claim 3, further comprising:
preparing the look-up table storing the water content percentage weight for the laundry object,
wherein the water content percentage weight for the laundry object is set to be proportional to a degree to which the laundry object belongs to the laundry image causing a water supply error.

6. The method of claim 5, wherein
the setting of the water content percentage weight for the laundry object comprises:
obtaining a first laundry image in a first washing process;
assigning error information to the first laundry image if a water supply error occurs in the first washing process;
obtaining an nth laundry image in an nth washing process;
assigning error information to the nth laundry image if a water supply error occurs in the nth washing process; and
setting a water content percentage weight to be proportional to a degree to which each laundry object belongs to the laundry image assigned the error information.

7. The method of claim 6, wherein
the setting of the water content percentage weight comprises:
extracting overlapping laundry objects overlapping each other, and non-overlapping laundry objects not overlapping each other, among laundry objects belonging to the first to nth laundry images; and
assigning the water content percentage weight such that the overlapping laundry objects have a water content percentage weight higher than the non-overlapping laundry objects.

8. The method of claim 6, wherein
the first laundry image to the nth laundry image are obtained from an image of the laundry placed in the washing tub.

9. The method of claim 8, wherein
each step of obtaining the first laundry image to the nth laundry image comprises obtaining a plurality of images, while tumbling the washing tub.

10. The method of claim 8, wherein
each step of obtaining the first laundry image to the nth laundry image is obtained by monitoring a clothing box disposed outside the washing tub.

11. The method of claim 1, further comprising:
receiving, from a network, downlink control information (DCI) used for scheduling transmission of the laundry image or the laundry classification information,
wherein the laundry image of the laundry or the laundry classification information is transmitted to the network on the basis of the DCI.

12. The method of claim 11, further comprising:
performing an initial access procedure with the network on the basis of a synchronization signal block (SSB),
wherein the laundry image of the laundry or the laundry classification information is transmitted to the network through a physical uplink shared channel (PUSCH), and the SSB and a demodulation reference signal (DM-RS) of the PUSCH are quasi-co-located, QCL, for a QCL type D.

13. An intelligent washing machine comprising:
a washing tub in which laundry is placed;
an image obtaining unit obtaining a laundry image of the laundry placed in the washing tub;
a water supply valve controlled to supply water to the washing tub for a reference water supply time in response to a washing command; and
a controller obtaining laundry classification information from the laundry image, calculating an estimated water supply time on the basis of the laundry classification information, and controlling the water supply valve to supply water for a period equal to or greater than the reference water supply time if the estimated water supply time is equal to or greater than the reference water supply time.

14. The intelligent washing machine of claim 13, wherein
the controller calculates the estimated water supply time to be equal to or greater than the reference water supply time if the laundry classification information includes error information indicating a water supply error history.

15. The intelligent washing machine of claim 13, wherein
the controller extracts a laundry object from the laundry image and searches for a water content percentage weight of the laundry object from a look-up table storing the water content percentage weight of the laundry object.

16. The intelligent washing machine of claim 15, wherein
the controller calculates the estimated water supply time to be equal to or greater than the reference water supply time if the sum of the water content percentage weights of the laundry items included in the laundry image is equal to or greater than a predetermined threshold.
